(19) United States
(12) Patent Application Publication
(10) Pub. No.: US 2020/0086835 A1
(43) Pub. Date: Mar. 19, 2020

(54) METHOD FOR BRAKING A VEHICLE, AND DRIVE TRAIN OF A VEHICLE

(71) Applicant: SCHAEFFLER TECHNOLOGIES AG & CO. KG, HERZOGENAURACH (DE)

(72) Inventor: Johannes LAMERS, Sasbach (DE)

(73) Assignee: SCHAEFFLER TECHNOLOGIES AG & CO. KG, HERZOGENAURACH (DE)

(21) Appl. No.: 16/614,545

(22) PCT Filed: Apr. 23, 2018
(86) PCT No.: PCT/DE2018/100387

§ 371 Date: Nov. 18, 2019

(30) Foreign Application Priority Data
May 22, 2017 (DE) 10 2017 111 108.5

(51) Int. Cl. B60T 8/17; B60T 7/12

(52) U.S. Cl. CPC B60T 8/17; B60T 7/12; B60T 2260/04; B60T 2270/30; B60T 2270/20; B60T 2270/10

(57) ABSTRACT

A drive train of a vehicle and a method for controlling a drive train is provided. The drive train includes a brake control unit configured to control vehicle brakes via, for example, hydraulic lines, and a transmission control unit coupled to the brake control unit via a data bus and configured to control a vehicle transmission. The transmission control unit is configured to command the brake control unit to activate the vehicle brakes in response to a detected defect in the vehicle transmission.

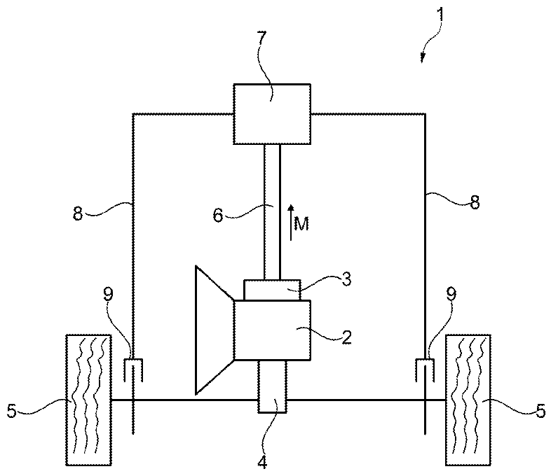

### CROSS-REFERENCE TO RELATED APPLICATIONS

This application is the U.S. National Phase of PCT/DE2018/100387 filed Apr. 23, 2018, which claims priority to DE 10 2017 111 108.5 filed May 22, 2017, the entire disclosures of which are incorporated by reference herein.

### TECHNICAL FIELD

This disclosure relates to a method for braking a vehicle, the vehicle having a transmission which is actuated by a transmission control unit, and to a drive train of a vehicle.

### BACKGROUND

DE 103 10 471 A1 has disclosed a double clutch transmission, in the case of which each part section within the transmission is assigned a transmission brake, with the result that each input shaft has its own brake which is positioned between the highest gear and the lowest gear.

DE 10 2009 021 894 B1 discloses a method for controlling a drive train of a motor vehicle, in the case of which method braking is carried out, in the case of a defect of the transmission, via a brake system which is actuated in an automated manner. The brake which is used to this end is configured as a transmission brake.

It may he disadvantageous here that a transmission with an integrated transmission brake has a very complicated construction and is therefore also very expensive to produce.

### SUMMARY

This disclosure is based on an object of specifying a method for braking a vehicle and a drive train of a vehicle, in the case of which reliable braking of the vehicle is possible via structurally simple methods in the case of a defect in the transmission.

According to the disclosure, the transmission control unit requests a brake intervention. Since the transmission control unit usually also detects the defect in the control unit, it can request a brake maneuver immediately, in order to rule out a risk situation in the vehicle.

The brake intervention which is requested electronically by the transmission control unit may be advantageously implemented by a vehicle brake. Here, a transmission brake can be dispensed with, since the brake intervention can be transferred very rapidly to the vehicle brake by way of the electronic request of said brake intervention.

In one refinement, the transmission control unit requests the brake intervention by a brake control unit which converts the request into a torque of at least one wheel brake which is configured as a vehicle brake. It is sufficient here if the transmission control unit carries out an electronic communication with the brake control unit. This simplifies the structural arrangement between the transmission control unit and the brake control unit.

The transmission control unit and the brake control unit advantageously communicate via a bus system of the vehicle. On account of the use of the bus system, the transmission control unit and the brake control unit can communicate rapidly with one another via command data sets.

In one variant, be (ore the communication between the transmission control unit and the brake control unit, the driving situation of the vehicle is checked in order to prevent an impermissible brake intervention. This ensures that the vehicle is not braked in a driving situation, in which the braking operation brings about a critical driving situation.

One embodiment relates to a drive train of a vehicle, in the case of which an engine drives wheels of the vehicle via a transmission, the transmission being actuated by a transmission control unit, and the vehicle having a vehicle brake Which is controlled by a brake control unit in order to brake the vehicle. In the case of a drive train of a vehicle, in the case of which a transmission brake can be dispensed with, the transmission control unit for electronically requesting a brake intervention is connected directly to the brake control unit for actuating the vehicle brake.

In the case of a hybrid vehicle, the transmission is advantageously configured as a hybrid transmission structure. Since hybrid transmission structures of this type which can be driven both by an internal combustion engine and by an electric motor are very complicated, an integration of a transmission brake into a hybrid transmission structure of this type can be dispensed with.

In one refinement, the transmission control unit and the brake control unit are connected to one another via a data line. As a result, a structural coupling between the transmission and the brake is dispensed with, since merely an electronic communication between the transmission control unit and the brake control unit is necessary.

In one embodiment, the brake control unit is configured as an ABS control unit or an ESP control unit or an ASR control unit. Therefore, various control units which are present in the vehicle per se and comprise a brake function can be utilized as a brake control unit. Therefore, a separate brake control unit can be dispensed with, which decreases the production costs of the vehicle.

### BRIEF DESCRIPTION OF THE DRAWINGS

The disclosure permits numerous embodiments. One of these is to be described in greater detail on the basis of the figures which are shown in the drawing, in which:

The Figure shows one exemplary embodiment of a drive train of a vehicle.

### DETAILED DESCRIPTION

The Figure shows one exemplary embodiment of a drive train 1 of a vehicle, in the case of which a transmission 2 is actuated by way of a transmission control unit 3. Here, the transmission 2 is connected via a differential 4 to vehicle wheels 5. Via a data bus 6, for example a CAN bus, the transmission control unit 3 is connected to a brake control unit 7, for example an ABS control unit. The brake control unit 7 of a brake actuator (not shown in further detail) is coupled via corresponding hydraulic lines 8 to in each case one of the wheel brakes 9 which lie opposite the vehicle wheel 5.

If a defect occurs in the transmission 2, which defect can consist in the case of a double clutch transmission for example in that a gear cannot be disengaged on a component transmission of the double clutch transmission, the vehicle rolls further and continues to accelerate, which involves a risk of an accident in the absence of a brake intervention. Said defect is detected by the transmission control unit 3. In this case, the transmission control unit 3 requests a brake intervention electronically by the brake control unit 7, in order for it to be possible for a controlling intervention of the transmission 2 to be performed. The brake control unit 7 converts the request of the transmission control unit 3 into a torque which is set at the wheel brakes 9, as a result of which the vehicle wheels 5 are braked by way of the wheel brakes 9.

Before the request of the brake intervention is output by way of the transmission control unit 3 to the brake control unit 7, the transmission control unit 3 checks whether the vehicle is in a driving situation, in which the brake intervention ensures reliable and accident-free braking of the vehicle. If said check leads to the result that a brake operation brings about an unsafe driving situation of the vehicle, the request of the brake intervention is not output to the brake control unit 7.

The request of a brake intervention by way of the transmission control unit 3 can also take place, however, in fault-free operation of the transmission 2. This is the case, fur example, in a transmission 2 which comprises a claw which becomes torque-free when the output is torque-free. A claw of this type can be opened only when it is torque-free. In the overrun mode of the vehicle, the claw is loaded and therefore cannot be opened. As a result of a brake request of the transmission control unit 3, however, the overrun torque of the vehicle wheels 5 can be conducted past the transmission 2 which has the claw into the vehicle brake 9 by way of the brake intervention. The transmission 2 and the claw are torque-free at that moment, and the claw can then be opened.

The vehicle drive train 1 which is shown in the figure comprises a front transversely mounted transmission. The invention is not restricted to a transmission of this type, however, but rather can be applied to all drive designs such as a standard drive, an all wheel drive and the like.

### LIST OF DESIGNATIONS

Drive train

Transmission

Transmission control unit

Differential

Vehicle wheel

Data bus

Brake control unit

Hydraulic line

Wheel brake

1. A method for braking a vehicle, the vehicle having a transmission which is actuated by a transmission control unit, wherein the transmission control unit requests a brake intervention.

2. The method as claimed in claim 1, wherein the brake intervention is requested electronically by the transmission control unit and is implemented by a vehicle brake.

3. The method as claimed in claim 2, wherein the transmission control unit requests the brake intervention by a brake control unit which converts the request into a torque of at least one wheel brake which is configured as a vehicle brake.

4. The method as claimed in claim 2, wherein the transmission control unit and the brake control unit communicate via a bus system of the vehicle.

5. The method as claimed in claim 2, wherein, before the communication between the transmission control unit and the brake control unit, the driving situation of the vehicle is checked in order to prevent an impermissible brake intervention.

6. A drive train of a vehicle, in the case of which an engine drives wheels of the vehicle via a transmission, the transmission being actuated by a transmission control unit, and the vehicle having a vehicle brake which is controlled by a brake control unit in order to brake the vehicle, wherein the transmission control unit for electronically requesting a brake intervention is connected directly to the brake control unit for actuating the vehicle brake.

7. The drive train as claimed in claim 6, wherein, in the case of a hybrid vehicle, the transmission is configured as a hybrid transmission structure.

8. The drive train as claimed in claim 6, wherein the transmission control unit and the brake control unit are connected to one another via a data line.

9. The drive train as claimed in claim 6, wherein the brake control unit is configured as an ABS control unit or an ESP control unit or an ASR control unit.

10. A drive train of a vehicle, the drive train comprising:
a brake control unit configured to control vehicle brakes via hydraulic lines; and
a transmission control unit coupled to the brake control unit via a data bus and configured to control a vehicle transmission, wherein the transmission control unit is further configured to command the brake control unit to activate the vehicle brakes in response to a detected defect in the vehicle transmission.

11. The drive train of claim 10, wherein the transmission control unit commands the brake control unit to activate the vehicle brakes in response to the vehicle operating in a safe driving situation.

12. The drive train of claim 10, wherein the detected detect includes a detection that a gear in vehicle transmission is unable to be disengaged.

13. The drive train of claim. 12, wherein the vehicle transmission is a double clutch transmission and the gear is a component within the double clutch transmission.
